(19) United States
(12) Patent Application Publication
(10) Pub. No.: US 2010/0310090 A1
(43) Pub. Date: Dec. 9, 2010

(54) SOUND AMPLIFICATION SYSTEM COMPRISING A COMBINED IR-SENSOR/SPEAKER

(75) Inventors: Roger Davis, Petaluma, CA (US); Michael Grall, Mountain View, CA (US); Andrew Parker, Petaluma, CA (US)

Correspondence Address: BUCHANAN, INGERSOLL & ROONEY PC, POST OFFICE BOX 1404, ALEXANDRIA, VA, 22313-1404, US

(73) Assignee: PHONIC EAR INC., Petaluma, CA (US)

(21) Appl. No.: 12/481,395

(22) Filed: Jun. 9, 2009

(51) Int. Cl. H04R 27/00

(52) U.S. Cl. 381/82

(57) ABSTRACT

A public address system including a wireless IR microphone for picking up a sound and converting it to an IR light signal including an audio signal representative of said sound and adapted for being transmitted to an IR sensor; an IR sensor including an IR photo detector for receiving said IR light signal and a first receiver for extracting said audio signal and a first transmitter transmitting it to a base station; a base station including a second receiver for receiving said audio signal from said IR sensor and a processor for processing said audio signal to provide a processed audio signal and a second transmitter transmitting it to a loud speaker; and a loud speaker unit for receiving said processed audio signal and converting it to a processed sound signal for being presented to an audience, wherein said IR sensor and loudspeaker unit are integrated into a sensor-speaker assembly.

### TECHNICAL FIELD

The present disclosure relates to wireless public address systems, e.g. to the amplification of a teacher's voice in a scholastic environment. The present disclosure deals in particular with the distribution of a sound signal picked up from a speaker's infrared (IR) microphone to a base station for signal processing and further redistribution to a number of spatially distributed loud speakers for presenting the sound in an auditory environment (e.g. a class room). The disclosure relates to a public address system, to its use and to a method of installing a public address system.

The disclosure may e.g. be useful in applications such as amplifying a teacher's voice in a classroom.

### BACKGROUND ART

The present disclosure relates e.g. to amplification of a teacher's voice in a class room environment. Such systems are e.g. described in EP 0 599 450 A2, U.S. Pat. No. 6,397,037 B1, US 2005/003330 A1, US 2006/0098826 A1, US 2008/0144844 A1 and WO 2008/087089 A1.

In the following the application of a sound amplification system based on an IR (infrared) wireless microphone in a teacher-classroom environment is described. The teacher speaks into the IR microphone (e.g. either located at a fixed position, e.g. a desk or hanging from the ceiling, or preferably attached to clothing or otherwise mounted on the body of the speaker), where an IR signal is transmitted and then detected by an IR sensor mounted on the ceiling or on a wall of the classroom. The recovered electrical signal is sent to a base station where the signal is e.g. processed to recover the audio signal, amplify it, and then play it back over a number of loudspeakers strategically located in the class-room. Unlike an electromagnetic radio wave signal (here termed, radio frequency, RF) that typically radiates in all directions, as well as through walls and other objects, an IR signal is an electromagnetic light signal (having much higher frequency and different propagation properties than radio wave signals). This light-based signal bounces off a typical wall or other interior surface and reflects back into the room. The fact that the signal reflects off of solid opaque surfaces is advantageous as there is no concern of the signal being inadvertently picked up in the next room, which offers an inherent level of security when compared to analog (or digital) RF signals. A disadvantage of IR signals is that the signal can easily be blocked, reflections are weak in energy, and ambient sunlight can reduce the dynamic range of the IR link. To address these issues, multiple sensors or large sensor arrays (typically a ceiling sensor) are often used to help provide proper coverage in the room. As this application is for a wireless public address (PA) system, loudspeakers are used to disperse the sound evenly in the room. A typical room equipped with a known PA-system usually has at least four loudspeakers mounted on the wall or in the ceiling to distribute sound evenly to avoid acoustic “hot spots” (even though using more speakers increases the likelihood of hot spots near the speaker itself). Installation of a system as described can be time consuming. The installation process typically requires placing at least 4 loudspeakers in strategic locations in the room and 1 to 3 IR sensors strategically located in the room as well. This corresponds to a minimum of 5 and as many as 7 cable runs which in turn corresponds to a long and costly installation process. Typical off the shelf loudspeakers are designed for musical playback and not speech intelligibility.

### SUMMARY OF THE DISCLOSURE

The disclosure relates specifically to co-locating a public address system's infrared signal reception device with one or more loudspeaker assemblies such that the total number of system components is reduced, and installation of the system is simplified without compromising the wireless effective range or the quality of the amplified sound field.

An object of embodiments of the present disclosure is to provide a public address system that is easy to install.

Further objects of embodiments of the disclosure are
1. Reduce Material Waste
2. Improve IR Coverage
3. Decrease or eliminate User Installation Error
4. Improve Sound Coverage
5. Improve Speech Intelligibility

Objects of embodiments of the disclosure are achieved by the disclosure described in the accompanying claims and as described in the following.

An object of embodiments of the disclosure is achieved by a public address system. The system comprises:
a wireless IR microphone for picking up a sound and converting it to an IR light signal comprising an audio signal representative of said sound and adapted for being transmitted to an IR sensor;
an IR sensor comprising an IR photo detector for receiving said IR light signal and a first receiver for extracting said audio signal and a first transmitter transmitting it to a base station;
a base station comprising a second receiver for receiving said audio signal from said IR sensor and a processor for processing said audio signal to provide a processed audio signal and a second transmitter transmitting it to a loud speaker unit; and
a loud speaker unit for receiving said processed audio signal and converting it to a processed sound signal for being presented to an audience, and

wherein said IR sensor and said loudspeaker unit are integrated into a sensor-speaker assembly.

This has the advantage of providing a system that is simple and easy to install.

In a preferred embodiment, the IR sensor and loudspeaker parts of the sensor-speaker assembly are enclosed in or supported by a common casing.

In a preferred embodiment, the system comprises first electrical conductors for transmitting said audio signal to said base station and second electrical conductors for transmitting said processed audio signal from said base station to said loudspeaker unit and wherein said first and second electrical conductors are located in the same electric cable. Alternatively, the system comprises one pair of conductors (e.g. a coaxial cable) and corresponding transmission and reception (multiplexing/de-multiplexing and/or filtering) circuitry to allow two-way transmission on the pair of conductors (e.g. using different frequency ranges in the transmission from the sensor speaker assembly to the base station than from the base station back to the sensor speaker assembly). Alternatively or additionally, the transmission between the sensor speaker assembly and the base station may be wireless, either one way or both ways (e.g. according to the Bluetooth standard).

In a preferred embodiment, the sensor-speaker system comprises two woofer elements, each having a midline defining a symmetry line of its acoustic polar directivity pattern wherein the two woofers are mounted in the assembly so that said midlines are twisted away from each other an angle −αand α, respectively, relative to a normal to a line connecting their geometrical midpoints (cf. e.g. FIG. 2a).

In a preferred embodiment, the twist angle a is in the range from 10° to 40°, e.g. in the range between 20° and 30°.

In a preferred embodiment, the parts of the sensor-speaker assembly, including the speaker elements, e.g. woofer and/or tweeter, are optimized for speech intelligibility.

In a preferred embodiment the system comprises two sensor-speaker assemblies, e.g. mounted on opposing walls of a room. In a preferred embodiment, two of the sensor-speaker assemblies are placed a specified distance B off-center from each other on opposite walls (B being the distance from a centre line CL). In a preferred embodiment, two of the sensor-speaker assemblies are placed at a nominal height C above the floor and/or a nominal distance D below the ceiling. The system may additionally comprise a ceiling mounted sensor speaker assembly.

Alternatively, a system may comprise a single, e.g. ceiling mounted, sensor speaker assembly. Preferably the ceiling mounted sensor speaker assembly is located at the geometrical centre of the intended acoustic and IR-coverage coverage area.

Use of a public address system described above, in the detailed description of ‘mode(s) for carrying out the disclosure’ and in the claims is furthermore provided. In an embodiment, use as a classroom amplification system is provided.

A method of installing a public address system is furthermore provided by an embodiment of the present disclosure. The method comprises:
a) providing a wireless IR microphone for picking up a sound and converting it to an IR light signal comprising an audio signal representative of said sound and adapted for being transmitted to an IR sensor;
b) providing an IR sensor comprising an IR photo detector for receiving said IR light signal, converting said IR light signal to an electrical signal and extracting said audio signal and transmitting it to a base station;
c) providing a base station for receiving said audio signal from said IR sensor and for processing said audio signal to provide a processed audio signal and transmitting it to a loud speaker unit;
d) providing a loud speaker unit for receiving said processed audio signal and converting it to a processed sound signal for being presented to an audience; and
e) providing that said IR sensor and said loudspeaker unit are integrated into a sensor-speaker assembly.

It is intended that the structural features of the system described above, in the detailed description of ‘mode(s) for carrying out the disclosure’ and in the claims can be combined with the method, when appropriately substituted by a corresponding process and vice versa. Embodiments of the method have the same advantages as the corresponding systems.

In a particular embodiment, the method comprises providing that said public address system comprises two sensor-speaker assemblies.

In a particular embodiment, the method comprises defining a coverage rectangle of substantially identical acoustic and IR coverage for said loudspeakers and said IR microphone/IR sensor combination, respectively. In a particular embodiment, the method comprises mounting said two sensor-speaker assemblies on opposite faces of said coverage rectangle. In a particular embodiment, the method comprises mounting said two sensor-speaker assemblies a predetermined distance B to each side of a midline dividing said opposing faces in equal halves of length A (cf. e.g. FIG. 2a). In a particular embodiment, the method comprises providing that the ratio B/A is in the range from 0.05 to 0.4, such as in the range from 0.1 to 0.2.

In a particular embodiment, the method comprises providing that the sensor-speaker system comprises two woofer elements, each having a midline defining a symmetry line of its acoustic polar directivity pattern and providing that the two woofers are mounted in the assembly so that said midlines are twisted away from each other an angle −α and α, respectively, relative to a normal to a line connecting their geometrical midpoints (cf. e.g. FIG. 2b). In a particular embodiment, the method comprises providing that said twist angle α is in the range from 10° to 40°, e.g. in the range from 20° to 30°.

In a particular embodiment, the method comprises mounting said sensor-speaker assembly at a height C above the floor and/or at a distance D from the ceiling (cf. e.g. FIG. 1). Preferably, C is in the range from 2.5 m to 3 m. In an embodiment, the ratio of D/(C+D) is in the range from 0.8 to 0.9.

In a particular embodiment, the method comprises providing that the speaker and IR sensor units of the sensor-speaker assembly or assemblies are tilted downward at a nominal angle β for optimized acoustic as well as IR coverage (cf. e.g. FIG. 2c). Preferably, the tilt angle β is in range from 20° to 40°.

Further objects of the disclosure are achieved by the embodiments defined in the dependent claims and in the detailed description of the disclosure.

As used herein, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements maybe present, unless expressly stated otherwise. Furthermore, “connected” or “coupled” as used herein may include wirelessly connected or coupled. As used herein, the term “and/or” includes any and all combinations of one or more of the associated listed items. The steps of any method disclosed herein do not have to be performed in the exact order disclosed, unless expressly stated otherwise.

### BRIEF DESCRIPTION OF DRAWINGS

The disclosure will be explained more fully below in connection with a preferred embodiment and with reference to the drawings in which:

FIG. 1 shows an exemplary speaker placement in a classroom for a public address system according to an embodiment of the disclosure,

FIG. 2 shows various mounting views of an exemplary speaker sensor assembly of a public address system according to an embodiment of the disclosure, FIG. 2a illustrating a top view including an exemplary Speaker Acoustic and IR Coverage Pattern, FIG. 2b illustrating a top view with speaker twist angle α, and FIG. 2c illustrating a side view with speaker tilt angle β,

FIG. 3 shows an exemplary signal path of a signal from audio source to loudspeaker in a public address system according to an embodiment of the disclosure,

FIG. 4 shows an exploded view of a sensor-speaker assembly according to an embodiment of the disclosure, and

FIG. 5 shows graphs (FIGS. 5a and 5b) of the loudspeaker's frequency response at different angles positions off of the center, or zero axis.

The figures are schematic and simplified for clarity, and they just show details which are essential to the understanding of the disclosure, while other details are left out.

Further scope of applicability of the present disclosure will become apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from this detailed description.

### MODE(S) FOR CARRYING OUT THE DISCLOSURE

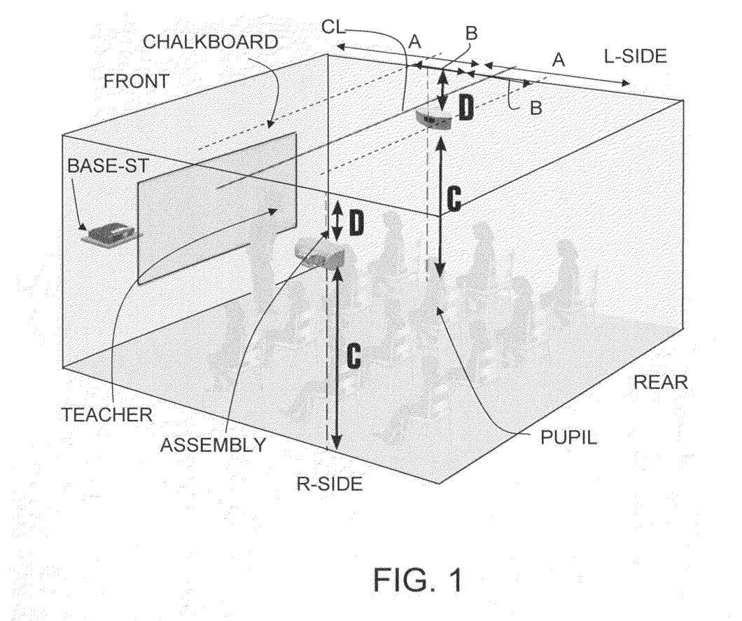

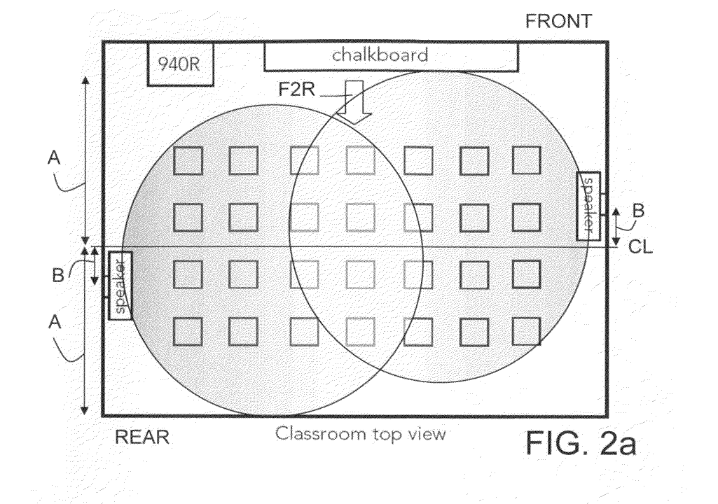

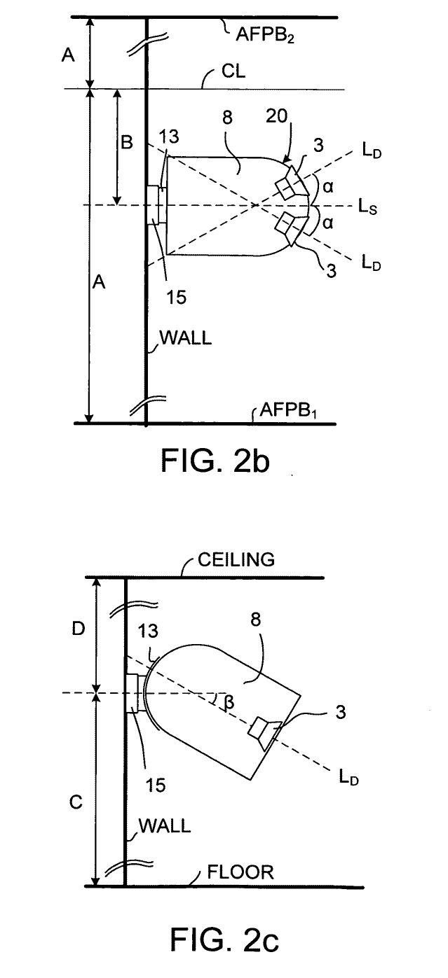

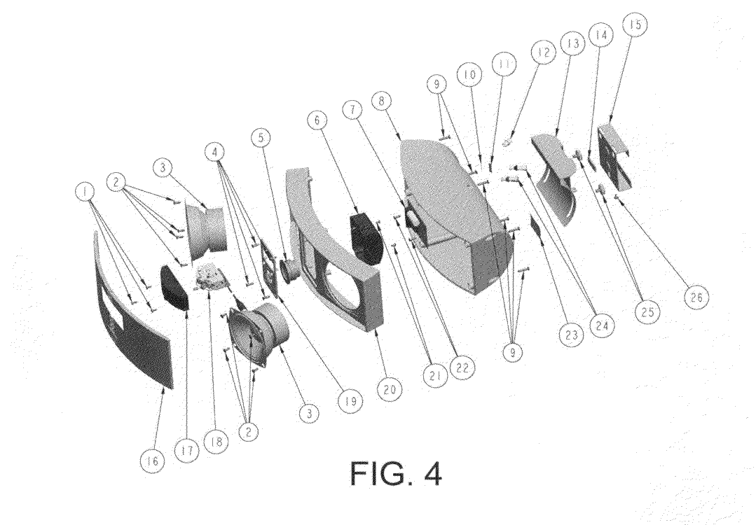

The sensor-speaker assembly is designed to address the installation time of a wireless PA system while still providing equivalent performance compared to prior art systems. Rather than installing 4 loudspeakers, the sensor-speaker assembly according to the present disclosure only requires 2 loudspeakers, strategically placed, to obtain equivalent coverage as four loudspeakers would provide. This is achieved by designing the sensor-speaker assembly to deliver the acoustic coverage and performance from one location that would normally require 2 speakers in 2 different locations. In an embodiment, each sensor-speaker assembly incorporates three speaker elements. It has turned out, that a proper placement of the wall-mounted loudspeaker is also a good location to place the IR sensor, so it makes logical sense to incorporate the sensor into the loudspeaker enclosure. IR coverage is thereby enhanced as there is now up to a 50% better opportunity for the IR microphone to be in line of sight with a sensor, when compared to a single, center ceiling mounted sensor that often relies on reflections. Preferably, the speaker enclosure design, driver selection, crossover design, and IR sensor coverage are carefully considered or optimized. In an embodiment, the sensor speaker assembly comprises two woofers and a mid-range speaker and/or a tweeter. The enclosure is e.g. configured to position the two woofers at a predetermined angle, e.g. 30 degrees, off horizontal to provide a wide dispersion of the low acoustic frequencies, cf. e.g. FIG. 2b and FIG. 4 (items (3), (20)). The crossover design is configured to route the higher frequencies to the tweeter before woofer lobes occurred while still maintaining a consistent nominal input impedance of 4 ohms (except for the driver SRF (SRF=electrical Self Resonant Frequency). The drivers are selected based on criteria of providing a natural sound for voice and efficiency of the transducer itself. The IR Sensor uses 3 highly sensitive photodiodes that are mounted at three predefined axis angles with 3 different axis positions, e.g. 0° and ±45°, to provide wide IR reception. FIGS. 1-3 illustrate parts of embodiments of the disclosure in a typical installation.

FIG. 1 shows an exemplary speaker placement in a classroom for a public address system according to an embodiment of the disclosure. The recommended room placements of the sensor-speaker assembly are depicted in FIG. 1. For optimum performance, two sensor-speaker assemblies are placed a specified distance B off-center from each other on opposite walls (B being the distance from a centre line CL located a distance A from each end of the room or from each end of opposing sides of a rectangle spanning the desired coverage, e.g. spanning the location of seats in a classroom or small auditorium) and at a nominal height C above the floor and/or a nominal distance D below the ceiling. The casing (including speaker and IR sensor units) of the sensor-speaker assemblies are shown tilted downward at a nominal tilt angle β for optimized acoustic as well as IR coverage. Preferably the walls whereon the sensor-speaker assemblies are mounted are the side-walls of the room wherein the speaker (e.g. a teacher) typically speaks from a front end (FRONT in FIG. 1, 2a) of the room towards a rear end of a room (REAR in FIG. 1, 2a). Examples of preferred values of these parameters are the following: A (5 m), B (1 m) or B/A (˜0.2), C (2.5 m), D (0.5 m), β (30°).

FIG. 2 shows various mounting views of an exemplary speaker sensor assembly of a public address system according to an embodiment of the disclosure, FIG. 2a illustrating a top view including an exemplary Speaker Acoustic and IR Coverage Pattern, FIG. 2b illustrating a top view with speaker twist angle α, and FIG. 2c illustrating a side view with speaker tilt angle β. The shaded area in FIG. 2a depicts the typical IR and acoustic field pattern, as viewed from the top, of a typical classroom. The two boxes denoted “speaker” represent two sensor-speaker assemblies. The square boxes represent student desks, here arranged in 4 rows as seen from the chalkboard side (FRONT) of the room. The box labelled 940R is the base station comprising IR Receiver/Amplifier. Even though the corners of the room are not represented in the shaded area there is still coverage. The shaded area represents the zone of consistent coverage. The centre line CL of FIG. 2 is preferably the centre line of a rectangle spanning the intended acoustic and IR field coverage (Acoustic Field Pattern Boundary, AFPB, cf. FIG. 2b), typically the room in question, here the midline of the arrangement of chairs for pupils when viewed in a direction from front to rear of the room (as indicated by arrow F2R in FIG. 2a). The preferred off-centre distance B for the location of the sensor-speaker assembly is indicated together with the midline→boundary coverage distance A.

FIG. 2b shows a top view of a room including a wall mounted speaker sensor assembly (as e.g. depicted in FIG. 2a). The assembly comprises a mounting element and a housing element, the housing element supporting at least the speaker units and preferably also the IR sensor elements, the mounting and housing elements being mutually adapted for adjustably mounting the housing element on a surface (e.g. a wall or a ceiling of a room). In the example of FIG. 2, the housing element 8 (cf. also FIG. 4) is mounted on a wall (WALL in FIG. 2b) using mounting bracket 13, 15 (cf. also FIG. 4) comprising wall mounting piece 15 and tilting piece 13. The focus of FIG. 2b is to indicate the twist angle α of two speaker units 3 (woofers, cf. (3) in FIG. 4) relative to a symmetry line L_{S} of the speaker sensor assembly or at least of the speaker assembly. The speakers are mounted on speaker and IR sensor mounting part 20 (cf. also FIG. 4) comprising a curved surface. The speaker and IR sensor mounting part 20 is supported by (possibly enclosed by) housing element 8. The orientation of a speaker is here defined by its acoustic directivity symmetry line L_{D} indicating a symmetry line of the acoustic coverage pattern of the speaker. The twist angle α is thus defined as the angle between L_{D} and L_{S}. For a symmetric resulting acoustic coverage pattern of a given speaker sensor assembly the angle α of both speakers with the symmetry line L_{S} of the assembly is chosen. Alternatively, different angles α₁ and α₂ may be used to provide an asymmetric acoustic coverage pattern, possibly to take account of irregularities of the room or of the intended acoustic field pattern (e.g. to implement deviations from rectangularity). Further, more than two speakers may be mounted on the speaker and IR sensor mounting part 20. The intended acoustic field pattern is spatially limited by the WALL and boundary lines AFPB₁, AFPB₂, possibly (but not necessarily) coinciding with physical room limitations (e.g. walls). A fourth acoustic field pattern boundary (AFPB) is not shown on FIG. 2b, but could e.g. be an opposing wall. The centre line CL of the AFPB is shown together with the characteristic distances A and B (relative to symmetry lines CL and L_{S}) having the meaning as explained in connection with FIGS. 1 and 2a. The dimensions of room and sensor speaker assembly are not to scale as indicated by the ‘))’ symbols intersecting the line representing the WALL.

FIG. 2c shows a side view of a room including a wall mounted speaker sensor assembly (as depicted in a top view in FIG. 2b). The focus of FIG. 2c is to indicate the tilt angle β of the housing element 8 (supporting the speaker units and IR sensor elements) relative to a line L_{M} perpendicular to the mounting surface (here WALL) of the speaker sensor assembly in a room, otherwise physically limited by CEILING and FLOOR. As further explained below in connection with FIG. 4, the mounting element (13, 15) comprises wall mounting piece 15 and tilting piece 13. The wall mounting piece 15 ensures a fixed, predefined mounting angle relative to a plane surface (wall or ceiling), here 90° given by line L_{M} perpendicular to the mounting surface (WALL). The curved tilting piece 13, to which housing element 8 is fastened, allows, via slots for fastening the tilting piece to the wall mounting piece 15 and/or to the housing element 8 (the housing element e.g. exhibiting a correspondingly curved outer contacting surface to the tilting piece), the speaker and IR sensor parts to be tilted relative to the mounting surface (cf. tilt angle β in FIG. 2c). The characteristic distances C and D relative to a line of symmetry L_{M} of the mounting element perpendicular to the mounting surface and having the meaning as explained in connection with FIG. 1 are further indicated. The dimensions of room and sensor speaker assembly are not to scale as indicated by the ‘))’ symbols intersecting the line representing the WALL.

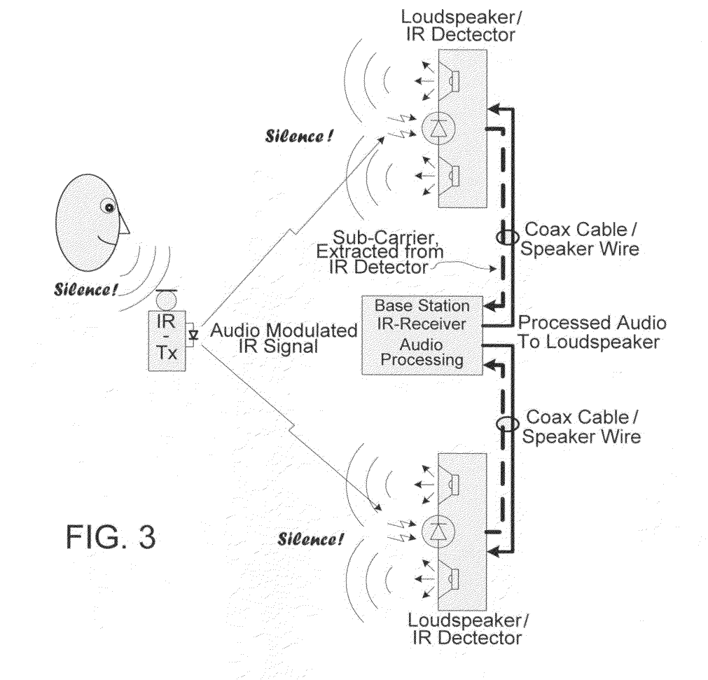

FIG. 3 shows an exemplary signal path of a signal from audio source to loudspeaker in a public address system according to an embodiment of the disclosure.

The public address system comprises an IR wireless microphone for picking up a sound, here supplied by a presenter, and converting it to an electric audio signal representative of the sound. The IR wireless microphone comprises a transceiver for modulating the audio signal onto an IR signal and for transmitting the IR signal to one or more IR sensors, here two are shown. The PA system further comprises two sensor-speaker assemblies and a base station. Each sensor-speaker assembly comprises an IR sensor comprising an IR photo detector for receiving the IR light signal and extracting the sub-carrier (2.3 MHz or 2.8 MHz in this scenario) signal and transmitting it to a base station via first electrical conductors of an electric cable and a loudspeaker unit for receiving and converting a processed audio signal to an output sound for being presented to an audience at the location of the PA system. The base station is adapted for receiving the sub-carrier signal from the IR sensor via the electric cable and for processing the audio signal and to provide a processed audio signal and transmitting it to the loud speakers of the two sensor-speaker assemblies via second electrical conductors of an electric cable. Preferably, the first and second electrical conductors are located in the same cable, whereby ease of installation is ensured.

To maintain the requirement for a shorter installation time, the connection cable used to interface between the sensor-speaker assembly and the base station is preferably a combined interference-resistant cable (e.g. coaxial, e.g. like RG-59U, e.g. from Alpha Wire Company, Elisabeth, N.J., USA) and a 2 conductor, stranded speaker cable from the same manufacturer. Only two cable assemblies are required for an installation rather than the typical five to seven separate cable runs. This will provide a nominal 50% reduction in installation time. It is possible to further simplify the cable assembly by simultaneously transmitting both the received IR signal and the amplified audio signal on a single, interference-resistant cable; in that case, additional components are required to separate the two signals.

Material is thereby used efficiently: There are only 2 speaker assemblies instead of 4 and 2 cable assemblies instead of 5 to 7 cables.

As the main application for the sensor-speaker assembly is sound reinforcement in a classroom, the acoustic properties of the speaker has been optimized for speech intelligibility. The sensor-speaker assembly's drivers were chosen to provide a natural sound when reproducing human voice without excessive bass response which can degrade intelligibility due to reverberation effects. Reverberation is usually associated with acoustic energy at low frequencies and larger woofers, which is good for music, but not good for speech intelligibility. A 4 inch driver is a good compromise as it can produce acoustic energy well for voice frequencies 120 Hz and higher while still reproducing appealing sound to recorded content.

The wide acoustic dispersion coverage provides a more uniform sound distribution so only 2 sensor-speaker assemblies are required. This reduces the number of acoustic hot spots by half. A computer acoustic simulation model predicts a 3 to 5% improvement in speech intelligibility over a 4 speaker solution.

Since the speakers are mounted on opposite walls, the IR sensors in the speaker enclosure are automatically located in strategic positions in the room to provide improved IR signal pick up. The sensor is designed to have the same coverage as the acoustic field of coverage. There is also less chance that an installer will place the speaker in a location that could potentially be blocked by another object in the room such as a wall mounted television. TV's are often mounted near or in the corner of a typical classroom and if 4 wall speakers are used the risk is greater that the installer will put one of the loudspeakers near the TV as the speakers are often mounted in on of the four corners.

The Sensor-speaker assembly according to an embodiment of the disclosure uses two 4 inch woofers and one 34 inch tweeter. The 2 woofers are mounted ±20 degrees off a horizontal axis (cf. e.g. FIG. 2b) to aid in achieving a wide dispersion pattern for the acoustical signal. The frequency crossover point (2 kHz) is also carefully chosen in order to best control the coverage over all range of frequencies. The IR Sensor is mounted above the tweeter and positioned in the center of the enclosure between the two woofers. In general, the IR sensor comprises at least one photo diode, but typically more than one, e.g. at least three. Here, the IR sensor is designed using 3 IR Photodiode arrays and the diodes are positioned to provide a wide coverage pattern.

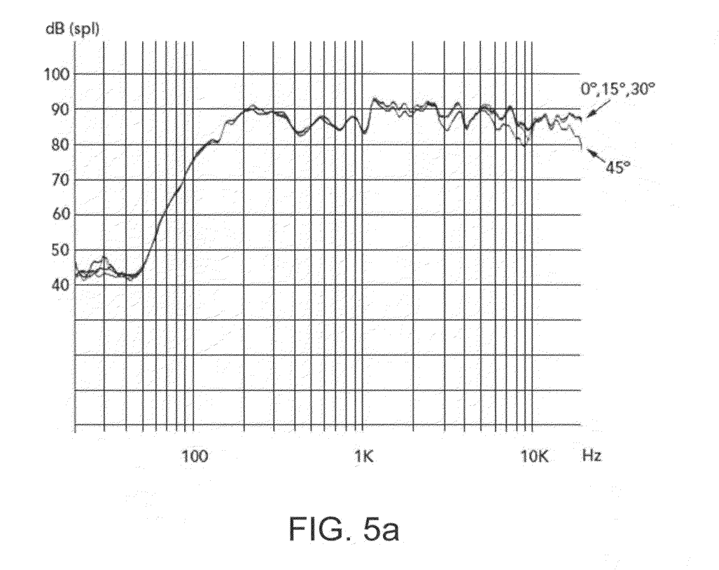

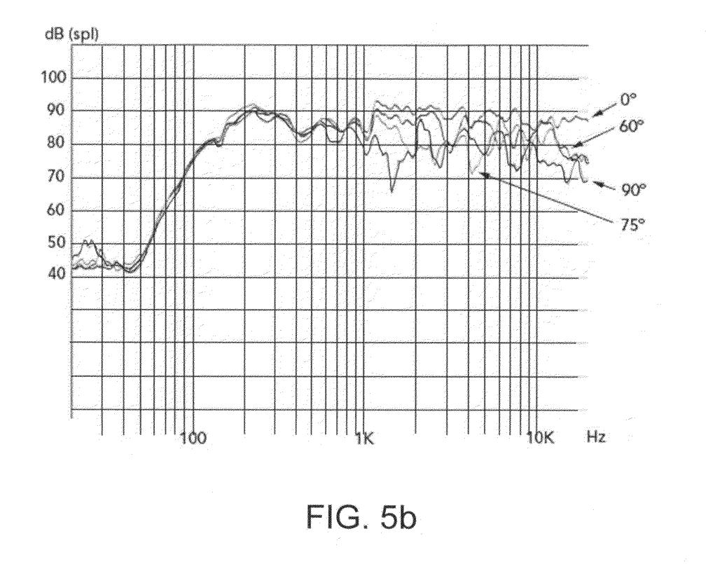

FIG. 4 shows an exploded view of a sensor-speaker assembly according to an embodiment of the disclosure. The unique components detailed in this view are (17) the IR sensor visible light filter, (18) the IR sensor array, (4) the custom tweeter plate that supports the sensor array and the (7) tweeter driver, (3) custom designed woofer, (6) tweeter/sensor enclosure used to isolate the woofer cavity, (7) custom crossover network, and (13, 15) a custom mounting bracket. Item (18) is the IR Sensor. The custom mounting bracket (13, 15) is designed for easy installation and positioning at the correct angle for both acoustic and IR coverage and comprises wall mounting piece 15 and tilting piece 13. The wall mounting piece 15 ensures a fixed, predefined mounting angle relative to a plane surface (wall or ceiling). The curved (e.g. a part of cylinder or a torus surface) tilting piece 13 (to which at least the loudspeaker and IR sensor parts are fastened) allows, via slots for fastening the tilting piece to the wall mounting piece, the speaker and IR sensor parts to be tilted relative to the mounting surface (cf. tilt angle β in FIG. 2c). The speaker and IR sensor mounting part (20) has a curved surface (e.g. a part of a cylinder surface) adapted for fixing the speakers (3, 5) and IR-sensor array (18). In particular, the curved surface is adapted to receive two woofer units (e.g. as shown via customized indentations or openings in the curved surface of the mounting part (20)) which, when mounted have preferred axes meeting at an angle 2α (cf. e.g. FIG. 2b) to ensure a good (low frequency) coverage of the acoustic signal. Items 3 (woofer), 5 (tweeter), and 7 (crossover network) are designed/selected to provide good spatial coverage of the acoustic signal. To ensure that a uniform power is delivered to the system the woofers have a nominal impedance of 8 ohms and are connected in parallel. The tweeter is 4 ohms. When coupled with the crossover, the network the system impedance is a nominal 4 ohms. The woofer cone construction uses a polymer material and the foam surround is treated with a UV coating to help maximize service life in a variety of environments. The crossover network uses a complete 1^{st} order design (6 dB low pass and 6 dB high pass) to ensure that the electrical energy as a function of frequency is maximized and is routed to the correct driver. The sensitivity rating of the drivers, coupled with the enclosure, are matched to provide a maximally flat response (cf. FIG. 5a, 0° trace).

FIG. 5 shows graphs of the loudspeaker's frequency response at different angle positions off of the center, or zero axis. FIG. 5a shows the polar acoustic dispersion (0°, 15°, 30°, 45°), the y and x-axes showing [dBspl] (spl=Sound Pressure Level) vs. [freq], respectively displayed in rectangular (x±y) form. FIG. 5b shows the polar acoustic dispersion (0°, 60°, 75°, 90°) the y and x-axes showing [dBspl] vs. [freq], respectively displayed in rectangular form. Two graphs are provided for clarity and a total of 7 angles at 15° increments are plotted. The plots are from 20 Hz to 20 kHz. As the plots indicate, the drop off of sound pressure level at different axis angles is still well controlled. There is no depreciable reduction in SPL (Sound Pressure Level) until the axis rotation is beyond 75 degrees. Normally, dispersion plots of this type are shown in polar format displaying dBspl versus angle at a specific acoustic frequency. The plots of FIGS. 5a and 5b sweep the frequency at six evenly spaced angles off the center axis. Only one side is shown as the negative axis will be nearly identical in a free field environment.

Embodiments of the disclosure are defined by the features of the independent claim(s). Preferred embodiments are defined in the dependent claims. Any reference numerals in the claims are intended to be non-limiting for their scope.

Some preferred embodiments have been shown in the foregoing, but it should be stressed that the invention is not limited to these, but may be embodied in other ways within the subject-matter defined in the following claims. The embodiments of a system according to the invention discussed above exhibit at least two, typically wall mounted sensor speaker assemblies. Other numbers of sensor speaker assemblies may of course be used, e.g. one or three or more. A system as described above may e.g. comprise a ceiling mounted sensor speaker assembly to supplement the coverage of the wall mounted assemblies. In a particular embodiment, the system comprises only one sensor speaker assembly, e.g. a ceiling mounted assembly.

### REFERENCES

EP 0 599 450 A2 (MATSUSHITA ELECTRIC) 1 Jun. 1994
U.S. Pat. No. 6,397,037 B1 (AUDIOLOGICAL ENGINEERING) 10 Dec. 1998)
US 2005/003330 A1 (Asgarinejad et al.) 6 Jan. 2005
US 2006/0098826 A1 (PHONIC EAR) 11 May 2006
US 2008/0144844 A1 (Shemesh et al.) 19 Jun. 2008
WO 2008/087089 A1 (PHONIC EAR) 24 Jul. 2008

1. A public address system comprising:
a wireless IR microphone for picking up a sound and converting it to an IR light signal comprising an audio signal representative of said sound and adapted for being transmitted to an IR sensor;
an IR sensor comprising an IR photo detector for receiving said IR light signal and a first receiver for extracting said audio signal and a first transmitter transmitting it to a base station;
a base station comprising a second receiver for receiving said audio signal from said IR sensor and a processor for processing said audio signal to provide a processed audio signal and a second transmitter transmitting it to a loud speaker unit; and
a loud speaker unit for receiving said processed audio signal and converting it to a processed sound signal for being presented to an audience,
wherein said IR sensor and said loudspeaker unit are integrated into a sensor-speaker assembly.

2. A public address system according to claim 1, wherein IR sensor and loudspeaker parts of the sensor-speaker assembly are enclosed in or supported by a common casing.

3. A public address system according to claim 1, wherein the system comprises first electrical conductors for transmitting said audio signal to said base station and second electrical conductors for transmitting said processed audio signal from said base station to said loudspeaker unit and wherein said first and second electrical conductors are located in the same electric cable.

4. A public address system according to claim 1, wherein the sensor-speaker system comprises two woofer elements, each having a midline defining a symmetry line of its acoustic polar directivity pattern wherein the two woofers are mounted in the assembly so that said midlines are twisted away from each other an angle −α and α, respectively, relative to a normal to a line connecting their geometrical midpoints.

5. A public address system according to claim 4, wherein said twist angle α is in the range from 10° to 40°.

6. A public address system according to claim 1, wherein parts of the sensor-speaker assembly, including the speaker elements, are optimized for speech intelligibility.

7. A public address system according to claim 1, wherein the system comprises first electrical conductors for transmitting said audio signal to said base station and for transmitting said processed audio signal from said base station to said loudspeaker unit and corresponding electric circuitry allowing such two-way communication.

8. A public address system according to claim 1, wherein the system comprises two sensor-speaker assemblies mounted on opposing walls of a room.

9. A public address system according to claim 1, wherein the system comprises a single sensor speaker assembly.

10. A method of amplifying a sound in a classroom comprising providing the public address system according to claim 1 and making a sound for the wireless IR microphone to pick up.

11. A method of installing a public address system comprising:
a) providing a wireless IR microphone for picking up a sound and converting it to an IR light signal comprising an audio signal representative of said sound and adapted for being transmitted to an IR sensor;
b) providing an IR sensor comprising an IR photo detector for receiving said IR light signal, converting said IR light signal to an electrical signal and extracting said audio signal and transmitting it to a base station;
c) providing a base station for receiving said audio signal from said IR sensor and for processing said audio signal to provide a processed audio signal and transmitting it to a loud speaker unit;
d) providing a loud speaker unit for receiving said processed audio signal and converting it to a processed sound signal for being presented to an audience; and
e) providing that said IR sensor and said loudspeaker unit are integrated into a sensor-speaker assembly.

12. A method according to claim 11, comprising providing that said public address system comprises two sensor-speaker assemblies.

13. A method according to claim 11, comprising defining a coverage rectangle of substantially identical acoustic and IR coverage for said loudspeakers and said IR microphone/IR sensor combination, respectively.

14. A method according to claim 12, comprising mounting said two sensor-speaker assemblies on opposite faces of said coverage rectangle.

15. A method according to claim 14, comprising mounting said two sensor-speaker assemblies a predetermined distance B to each side of a midline dividing said opposing faces in equal halves of length A.

16. A method according to claim 15, comprising providing that the ratio B/A is in the range from 0.05 to 0.4.

17. A method according to claim 11, comprising providing that the sensor-speaker system comprises two woofer elements, each having a midline defining a symmetry line of its acoustic polar directivity pattern and providing that the two woofers are mounted in the assembly so that said midlines are twisted away from each other an angle −α and α, respectively, relative to a normal to a line connecting their geometrical midpoints.

18. A method according to claim 17, comprising providing that said twist angle α is in the range from 10° to 40°.

19. A method according to claim 11, comprising mounting said sensor-speaker assembly at a height C above the floor and/or at a distance D from the ceiling.

20. A method according to claim 11, comprising providing that the speaker and IR sensor units of the sensor-speaker assembly are tilted downward at a nominal angle β for optimized acoustic as well as IR coverage.
